(19) United States
(12) Patent Application Publication
(10) Pub. No.: US 2021/0331946 A1
(43) Pub. Date: Oct. 28, 2021

(54) SYSTEM FOR REMOVING CONTAMINANTS FROM FLUIDS AND RELATED METHODS

(71) Applicant: Steven Wilson, Shafter, CA (US)

(72) Inventor: Robert Mizner, Shafter, CA (US)

(21) Appl. No.: 17/213,075

(22) Filed: Mar. 25, 2021

Related U.S. Application Data
(60) Provisional application No. 63/023,826, filed on May 12, 2020.
(60) Provisional application No. 63/016,873, filed on Apr. 28, 2020.

(51) Int. Cl. C02F 1/463; C02F 1/461; C02F 1/44; C02F 1/00

(52) U.S. Cl. CPC C02F 1/463; C02F 1/46109; C02F 1/44; C02F 1/008; C02F 2101/306; C02F 2209/40; C02F 2201/46135; C02F 2209/02; C02F 2209/06; C02F 2001/007

(57) ABSTRACT

The present invention provides a system and method for treatment of wastewater from industry, particularly water contaminated with pesticides, herbicides, and other contaminants. The system improves efficiency of contaminant removal from waste waters, reducing the volume and mass of the extracted waste and increasing the yield of usable water. Particularly, the system and method of the present invention provides improved electrocoagulation systems and techniques.

### FIELD OF THE INVENTION

The present invention relates generally to a system for removing contaminants from waste water and methods of making and using the same. More particularly, the present invention relates to improved contaminant electrocoagulation and removal system and related methods.

### BACKGROUND OF THE INVENTION

Organic compounds produced or used in industrial processes can contaminate the water used in such processes. Agricultural operations use large quantities of herbicides and pesticides that are environmentally hazardous and disposal of such chemicals is tightly regulated. Also, many industrial plants, such as petrochemical refineries and gas plants, and service operations that utilize petrochemicals and other harmful materials generate wastewater that is laden with harmful contaminants, including heavy metals, petrochemicals, solvents, etc. Such wastewater is not easily disposed of, and presents a significant logistical and economic problem for such operators. The contaminants must be removed from the wastewater before the water can be introduced into the environment or used for another purpose.

Several different kinds of contaminants can be removed from water using electrolytic treatment, including metals, proteins, microbes, oils, and other contaminants through electrocoagulation techniques. However, conventional electrocoagulation systems have limited efficacy. Such systems are typically used only on fluids having relatively low contaminant concentrations. These systems are particularly inefficient in removing contaminants from fluids with high concentrations of organic compounds, such as herbicides and pesticides. Also, the removed contaminants retain a large amount of water that results in both a smaller yield of purified water and a higher volume of waste for disposal. Improved water purification systems are needed.

There remains a need for improved electrocoagulation systems that are operable to remove organic compounds and other materials from wastewater in an efficient manner, allowing for an effective mechanism for reclaiming water from industrial, agricultural, and other contaminating uses.

### SUMMARY OF THE INVENTION

The present invention relates to a system and method for treatment of wastewater from industry, particularly water contaminated with pesticides, herbicides, and other hydrocarbon-based and/or oily substances. The system improves efficiency of contaminant removal from waste waters, reducing the volume and mass of the extracted waste and increasing the yield of usable water. Particularly, the system and method of the present invention provides improved electrocoagulation systems and techniques. Electrocoagulation is a process of applying an electric field to a liquid, e.g., by passing the contaminated fluid through a charged structures (e.g., electrodes) having electric potentials therebetween. Physio-chemical reactions are induced by the applied electrical potentials, in which metal ions, colloids, and soluble inorganic particles are suspended in solution by electrical charge and removed from solution by introducing positively charged metal ions from a cathode and hydroxyl ions formed from water around an anode into the contaminated water. This initiates a coagulation process in which the charged metal ions attract negatively charged contaminants and then agglomerate into larger particles by precipitation and absorption producing aggregates and flocculant particles that then drop out of solution. These flocculent particles are managed either by flotation collection or gravitational settling in a chamber.

The present electrocoagulation system improves on the deficiencies of conventional systems, particularly by removing hydrocarbon contaminants to a level that meets environmental regulations at the state (California's Total Threshold Limit Concentration [TTLC]) and federal (Toxic Characteristic Leaching Procedure [TCLP]) levels for content limits on metals, volatile organics, semi-volatile organics, pesticides, herbicides, polychlorinated biphenyls (PCB), and other restricted chemicals. The electrocoagulation system of the present invention removes contaminants from aqueous fluids, such as wastewater, by (1) migration to oppositely charged electrodes and resulting aggregation due to charge neutralization, (2) chemical oxidation-reduction reactions that convert organic materials to less toxic species (e.g., dehalogenation, etc.) and to species that are more amenable to coagulation with metal cations produced by the charged electrodes present in the electrocoagulation reaction vessel, (3) precipitate formation between charged pollutants and metal cations and hydroxyl ions, and (4) allowing adequate coagulation and settling time for flocculant to agglomerate and fall out of the treated wastewater. The presently disclosed process is operable to reduce contamination in fouled water to comply with government regulations on wastewater use, e.g., for irrigation, gray water, air conditioning, commercial laundry, and other reclamation uses.

In particular, the system of the present invention removes dissolved or suspended metal and organic contaminants, such as chemicals found in herbicides and pesticides that render wastewater unusable. The electrocoagulation device of the present invention includes an electrocoagulation reactor, a direct current (DC) electrical power source (e.g., a rectifier), a vessel container for the electrocoagulation reactor, a system pressure pump, valves and piping to direct the flow of fluid, a monitoring and control system, and a filter system for collecting contaminant aggregations and flocculant particles.

The system includes an electrocoagulation reactor with a DC power source (e.g., a rectifier) having an enclosure with a plurality of electrode plates disposed therein. The electrode plates are separated from each other but remain in direct contact with the wastewater as it flows between the electrodes. Each of the electrodes may have both positive and negative electrical leads connected thereto in order to facilitate switching of polarity in the electrode plates. Adjacent electrodes are charged with opposite polarities in order to generate an electrical potential therebetween. However, this electrical potential will break down in wastewater contaminated with organic contaminants like pesticides and herbicides due to charge accumulation on the electrodes. To prevent charge accumulation, the present methods include changing the polarity of adjacent electrodes at a pre-determined interval that both maintains electrical potential, prevents passivation of the electrodes, and provides even dissolution of the electrodes over time. The electrocoagulation reactor may be enclosed on all sides by exterior insulating plates of a non-conductive material (e.g., a polymeric or plastic material).

The electrocoagulation reactor may be configured to optimize the exposure time, mixing of the fouled water passing through the electrocoagulation reactor, and the ratio of the surface area of the electrodes to the volume of the fouled water flowing through the reactor. The electrode plate geometry and material of the present invention are novel and contribute to the improved efficiency of the electrocoagulation performed by the system of the present invention. The present electrocoagulation reactors include relatively large electrode surface areas. In some embodiments, the parallel plate electrodes are disposed on the support enclosure so as to be parallel with the direction of fluid flow between the electrode plates. During electrocoagulation, several electrodes plates can be used to achieve a certain surface area per unit volume of wastewater. This is the combined surface of the electrodes in relation to the volume of the wastewater to be treated. The electrodes themselves can be made from various materials. Aluminum is a preferred electrode material, and, in particular, aluminum alloys that include magnesium and/or chromium. For example, the electrode plates may be made from a 5052 aluminum alloy. These aluminum alloys perform better than other materials for breaking down organic molecular contaminants, like herbicides and pesticides. The aluminum alloy electrodes produce Al³⁺ ions in the wastewater. The Al⁺ ions have a comparative advantage in chemically converting organic molecules in the wastewater relative to other alternative materials, such as iron and steels. The aluminum alloys discussed above provided the best results in purifying and clarifying wastewater fouled with herbicides and pesticides. However, it should be noted that other conducting material (e.g., iron, mild steel, stainless steel, hybrid aluminum/iron materials, etc.) can be used.

The Al⁺ ions are highly charged (more so than the divalent Fe′ that result from steel electrodes), trivalent cations form monomeric and polymeric hydroxo complex species having high absorption properties that form strong aggregates with the hydrocarbon and other types of contaminants in the fouled water. The higher power levels supplied to the electrodes in the present electrocoagulation system generate a higher concentration of Al³⁺ ions in the fouled fluid. Aluminate ions may be produced at the electrode, which may then form aluminum-hydroxide complexes with the contaminants though electrostatic attraction, complexation, and coagulation. H₂ and O₂ gas may be generated at the surface of the electrodes due to electrolysis. These gases interact with the coagulated complexes and raise the coagulant to the surface of the fluid in the reaction tower as the gas bubbles rise to the surface of the fluid. This causes coagulated complexes to form a foam at the surface of the fluid that can be discharged into settling tanks, where it can be separated from and filtered out of the fluid to yield a reclaimed, clean water effluent.

The aluminum hydroxo species coagulated complexes generated by the present invention denser, with less water content than those generated by conventional processes and more shear resistance, and are thus easier to dewater. Thus, the coagulated heterogenous fluid produced by the reaction tower of the present invention more completely removes the contaminants of the fouled water and allows for effective separation of the coagulated contaminant material from the fluid. This allows for the production of a water effluent that is non-hazardous and meets high regulatory standards.

The ratio of the surface area of the electrodes to the volume of the fouled water in the reactor at any given moment may be in the range of about 1 in²/in³ to about 5 in²/in³. The electrodes of the reactor may be shaped and positioned to create a flow pathway through the reactor that provides spatial closeness between the electrodes to create sufficient potential therebetween, creates some turbulence in the water to cause mixing and dispersion of the fouled water to encourage interactions of charged ions (e.g., metal cations, charged metal oxides, etc.) with charged organic materials to maximize complexing and coagulation of the contaminants in the fouled water. For example, the electrodes may have a flat, plate structure with a height in a range of about 36 inches to about 84 inches (e.g., about 4 feet, about 5 feet, or any value or range of values therein), each with one distal end cut (a docked end) at an oblique angle (e.g., in a range of about 10° to about 45°) that allows for a gap between the angled distal end and an interior wall of the reactor to allow the fouled water to flow therebetween. The electrode plates may be arranged in parallel within the reactor with predetermined spacing between the electrode plates, and the docked ends of the electrode plates in a staggered arrangement such that the docked end of an electrode plate is horizontally flipped with respect to an adjacent electrode plate. This arrangement allows for the free flow of the fouled water through the reactor, while causing turbulence and mixing at the docked ends of the electrode plates due to a convoluted flow pathway created by the staggered docked ends of the electrode plates.

In some embodiments, and without limitation, the electrode plates may be spaced apart from each other to improve the ratio of electrode surface area to volume of the volume of fouled water passing through the reactor. For example, the electrodes may be arranged substantially parallel to each other and may be spaced apart by a distance in a range of about 0.1 inches to about 2 inches (e.g., about 0.125 inch to about 0.5 inch), such that a strong electrical potential is maintained between adjacent electrodes and there is a high surface area to volume ratio between the surface of the electrodes and the volume of fouled water. The reactor may include 10 to 20 electrodes each having a surface area in a range of about 450 in² to about 1200 in², and the volume of fouled water present in the reactor at any given moment is in a range of about 10 gallons to about 55 and may pass through the reactor at a rate of about 0.5 gallons per minute to about 15 gallons per minute. In a specific example, the reactor may have electrode plates with a length of about 48 in, a width of about 5.5 in, and a docked end with an angle of about 25°, giving each of the electrode plates a surface area of about 514 in². The reactor may have a volume of about 2,550 in³ with the electrode plates parallel and spaced apart by a distance of about 0.5 in. In this example, the ratio of the surface area of the electrodes to the volume of the fouled water present at any given moment in the reactor may be about 3.2 in²/in³.

Additionally, the voltages and currents applied to the electrodes according to the presently disclosed methods are higher than in conventional systems because of the additional energy required to sufficiently breakdown organic molecules such as pesticides and herbicides present in waste water into less toxic species to meet government regulations on wastewater use for irrigation, gray water, air conditioning, commercial laundry, and other reclamation uses. The present electrocoagulation system may utilize a specially made rectifier for applying high voltage and current levels to the electrocoagulation tower with polarity switching operability at pre-determined intervals that maintains electrical potential in the wastewater sufficient to chemically breakdown the contaminants at a consistent rate, thereby increasing the efficiency and efficacy of the system. The voltages applied by the rectifier of the presently disclosed systems and methods may be in a range of about 12 V to about 40 V. The currents applied in the present system may be about 400 amps to about 1500 amps (e.g., about 500 amps to about 900 amps). To deliver the relatively high voltages and currents of the presently disclosed electrocoagulation systems, the electrical systems are more robust. The present system may use large gauge copper lines to deliver current from a rectifier to the contact points for the plate electrodes. For example, and without limitation, current may be delivered to the electrodes via conductive lines (e.g., rods) having a diameter in a range of about ¼ in. to about % in (e.g., about ½ in rods or lines) to improve the efficiency of the flow of electricity and facility high voltage and current delivery to the electrode plates. The conductive lines may comprise copper, aluminum, gold, platinum, or other highly conductive metals. In some embodiments, copper is used due to its relatively low cost and high conductivity. The conductive lines may each be connected to one more electrodes in the coagulation reactor by branching into subleads connecting directly to the plates to deliver electricity thereto. Each of the subleads may be connected to the electrode plates by a high surface area conductive contact (e.g., a clamp) to provide a contact operable to deliver a large amount of voltage and current to the electrode plate efficiently. For example, the contact surface area of the conductive contact for each of the subleads may be in a range of ¼ in² to about 1 in.². The connections of the conductive lines may be arranged such that the polarity of the plates alternate between positive and negative, and thus conductive lines of opposite polarity are connected to each set of adjacent plates.

In some embodiments, the rectifier may be operable to provide the high voltage and current levels required by the present systems and methods to break down organic chemicals (e.g., pesticides and herbicides) present in the wastewater. For example, the rectifier may be operable to deliver a constant electrical current of about 400 amps to about 1500 amps (e.g., about 500 amps to about 900 amps) with a constant voltage of about 12 V to about 40 V, while maintaining the target current and voltage within about 1% variance. The rectifier may also include a rectification waveform filter, a bridge converter circuit, and a transformer rectifier circuit.

The rectifier may be operable to deliver DC power of opposite polarities to two sets of electrical lines, such that adjacent electrode plates in the coagulation reactor can be of opposite charge. The opposite charges on alternate electrodes may generate a strong electric field between adjacent electrodes to induce redox reactions in organic molecular contaminants in the wastewater and cause metal from the cathode to ionize and go into solution for interaction with the contaminants in the fluid as it flows through the electrocoagulation reactor. The DC electrical power supply of some embodiments of the present invention includes automatic adjustment of the voltage to provide a constant preset current to the electrode plates and automatically reverses the direction of current at adjustable preset intervals. The higher applied voltages of the present invention lead to for a period of at least about one minute (e.g., in a range of about one minute to about 5 minutes, a range of about 1 minute to about 3 minutes, or any value or range of values therein). The applied voltage range allows for the polarity of the electrodes to be maintained for an amount of time such that the time lost in switching the polarities of the electrodes and re-establishing a reversed electrical potential between adjacent electrodes is a small proportion of the total processing time, and introduces negligible inefficiency. The time lost in effective electrocoagulation due to switching polarity can be on the order of fractions of a second to seconds depending on multiple factors. The shorter the time period between polarity reversals, the higher the proportion of process time is taken up during the polarity reversal process and the more inefficiency in the process. Some conventional processes reverse polarity of electrodes every few seconds (e.g., about every ten seconds, about every 20 seconds, and other short timeframes). In such systems, proportions of about 5% to about 20% of processing time may be lost due to the polarity reversal period. The high current ranges applied to adjacent electrodes of the present invention may be sufficient to maintain an electrical potential between adjacent electrodes sufficient to induce significant electrocoagulation even with the lag in applied electrical power that occurs during the polarity switching process.

The coagulated materials may rise to the top of the electrocoagulation tower as discussed above, where the coagulated material may be transmitting via conduit to settling chambers for removing the coagulated material from the fluid to produce a non-hazardous, low-contaminant effluent. A collection conduit may be positioned at or near the top of the pre-determined fluid level of the electrocoagulation tower to drain the fluid with the floating coagulated material into one or more settling chambers in a settling module. Each of the one or more settling chambers may include a rigid structural frame (e.g., metal, composite plastics) and may be operable to nest a porous filter material therein. The settling chambers may include a plurality of chambers, each of which functioning individually, or the settling chambers may be connected in sequence to perform sequential filtration of the effluent. The porous filter material may be a material having a pore size in a range of about 1 μm to about 10 μm, which is sufficient to capture the coagulated material therein. The water in the effluent may pass through the porous material and be collected via conduit to a collection tank. The filter material may be reusable, water permeable, and operable to collect sludge. Example materials for the filter material include textile cloths comprising cotton threads, cellulose acetate, nylon threads, rayon threads, polyester threads (e.g., spun polyester, filament polyester, etc.), and other materials usable to produce a woven cloth-like filter membrane. A particular example of the filter material is banner cloth having a pore size of about 1 μm to about 10 μm (e.g., about 5 μm). The textile material may be lifted out of the rigid structural frame to remove the captured coagulated material from the filter material.

The settling system may have at least one settling chamber, and may have a plurality of settling chambers (e.g., three settling chambers). In some of the embodiments, each of the settling chambers may be separate, each having a filter bag with the same pore size, and working in parallel. In such embodiments, the parallel settling chambers allow for simultaneous settling of coagulated contaminant from a large volume of fluid. The effluent fluid may be allowed to remain in the tank for an extended period to allow for the coagulated material to settle out of the fluid into the filter material for an extended period. Each of the settling chambers may have a volume in a range of about 50 gallons to about 200 gallons: e.g., in a range of about 80 gallons to about 150 gallons; in a range of about 100 gallons to about 130 gallons; or any value or range of values therein. The volume of the filter bags nested within the settling chambers may have a volume of about 50% to about 80% of the volume of the settling chamber in which they are nested. The filter bags may have a perimeter shape that is complementary shape to the interior frame of the settling chamber, and may be suspended at or near the top rim of the settling chamber such that the vertical depth of the filter bag is less than that of the settling chamber. The relative size and shape of the filter bag allows the cleaned filtrate water to pass through the filter bag into the bottom of the settling chamber, where it can be drawn out of the settling chamber into a holding tank or other destination. Each of the settling chambers may have its own drainage pipe for collecting the cleaned water filtrate.

In other embodiments, the settlement chambers may be set up in a sequential filtering arrangement, with each settlement chamber having a finer filter material to remove finer coagulated particles. For example, the first settling chamber may have a filter material with a pore size in a range of about 10 μm to about 50 μm to remove large coarse coagulated particles; a second settling chamber may have a filter material with a pore size in a range of about 5 μm to about 20 μm; and a third settling chamber may have a filter material with a pore size of about 1 μm to about 10 μm for capturing fine coagulated particles. In such embodiments, the filtrate water from each settlement chamber may be collected at the bottom of the settling chamber, passed through a drainage conduit to the upper opening of the next settling chamber in the sequence so that it can be refiltered through a finer filter membrane. The fluid may be moved from one settling chamber to the next by a fluid pump in fluid communication with the drainage conduit (e.g., a centrifugal pump, a piston pump, etc.). The filtrate may be drained from the final settling chamber in the sequence via drainage pipe to a holding tank or other destination. The size, shape and arrangement of the settling chambers and the filter bags may otherwise be the same as the embodiments described immediately above.

The electrocoagulation system may include a monitoring and control system that includes a programmable logic controller and sensors mounted in the outlet piping for flow, temperature, pressure, and pH; and interconnecting wiring. The system may include a DC electrical power supply for the electrocoagulation reactor that may be operated by a remote control, touch screen interface, and/or remote monitoring system. The PLC may be operable to control and calibrate all the essential functions of the system. Functions may include monitoring and regulating the volumetric flowrate of untreated water, the control and calibration of a voltage output to the electrodes by the rectifier using a voltage regulator. The PLC may retrieve and store a series of controller commands from the computer storage in the memory of the controller. A control panel and secondary electrical systems may be stored in the PLC enclosure.

The flow rate of untreated water may be monitored by a flow meter present in the electrocoagulation tower. The flow rate of the present system may be maintained by the PLC at a rate in a range of about at a rate of about 0.5 gallons per minute to about 15 gallons per minute (e.g., about 2 gallon to about 10 gallons per minute), and may be adjusted and controlled with a reduction of voltage to a pump present in the system (e.g., a centrifugal pump, high-pressure pump) located either upstream or downstream of the electrocoagulation tower. The temperature of the fluid may be monitored using numerous sensors (e.g., thermocouples) placed at strategic locations within the system. The pressure may be monitored with a pressure sensor (e.g., pressure transducer, piezometers, and manometer) and compared to a predetermined pressure stored in the PLC's memory. The pH of the contaminated fluid may be measured using a pH sensor, which may report a value to the PLC and compared the value to a database for determining the next stage of the process. The pH of the contaminated fluid may be maintained in a basic range, e.g., in a range of about pH 8 to about pH 11.

Several embodiments are discussed below, but the example embodiments shall not be interpreted as an exhaustive list. One with ordinary skill in the art will recognize that the scope of the present invention includes further variations and equivalents to the specific examples described herein.

In one aspect, the invention relates to an electrocoagulation system for removing contaminants from a flow of wastewater comprising a wastewater container for receiving and storing wastewater; an electrocoagulation reactor in fluid communication with the wastewater container having a plurality of electrode plates positioned at a predetermined spacing and substantially parallel to each other; a DC voltage source in electrical communication with the plurality of electrode plates for applying a voltage therebetween; a rectifier in electrical communication with the DC voltage source to selectively reverse the polarity of the voltage supplied to the electrode plates at a predetermined interval; and a plurality of settling tanks having filter membranes for collecting coagulated materials from the wastewater. The system may further comprise a controller adapted to control the flow of wastewater from the wastewater source, through the electrocoagulation reactor, and into the settling tanks, and to control the rectifier and the DC voltage source to control the amount of voltage supplied to the plurality of electrode plates. The rectifier may change the polarity of the electrode plates to allow the electrode plates to deteriorate substantially equally and to maintain electrical potential between adjacent plates, the rectifier being controlled by the controller. Each of the plurality of electrode plates may be comprised of an aluminum alloy. The aluminum alloy may comprise aluminum, chromium, and magnesium. The aluminum alloy may be 5052 aluminum alloy. The positive and negative electrode plates may have a substantially rectangular shape with an angled cut at one distal end thereof. The system may further comprise a temperature sensor to measure the temperature of the wastewater exiting the reactor, the temperature sensor in communication with the controller, the controller adjusting the flow of wastewater and the DC voltage source to achieve a desired temperature of wastewater exiting the reactor. The system may further comprise a pH sensor located between the reactor and the settling tanks to measure the pH of the wastewater exiting the reactor, the pH sensor being in communication with the controller, wherein the controller is operable to adjust the flow of wastewater and the DC voltage source to achieve a desired pH of wastewater exiting the reactor. The electrode plates may be vertically disposed. Each of the plurality of electrode plates may have a positive lead and a negative lead in electrical communication with the rectifier. The system may further comprise a pump operable to move the wastewater from the wastewater container to the electrocoagulation reactor and the plurality of settling tanks. The wastewater may comprise concentrations of pesticides in a range of about 1% wt/wt to about 50% wt/wt. The system may be operable to remove the pesticides to achieve a filtrate having a concentration of pesticides in a range of about 1% wt/wt to about 50% wt/wt. The wastewater may comprise concentrations of herbicides in a range of about 1% wt/wt to about 50% wt/wt. The system may be operable to remove the herbicides to achieve a filtrate having a concentration of pesticides in a range of about 1% wt/wt to about 50% wt/wt. The wastewater may comprise concentrations of organic pollutants in a range of about 1% wt/wt to about 50% wt/wt. The system may be operable to remove the organic pollutants to achieve a filtrate having a concentration of pesticides in a range of about 1% wt/wt to about 50% wt/wt. The system may be operable to apply a current to the electrodes in a range of about 550 amps to about 700 amps and to pass the wastewater through the electrocoagulation reactor at a rate in a range of about 0.5 gallons/minute to about 15 gallons/minute, and thereby remove the organic pollutants to achieve a filtrate having a concentration of pesticides in a range of about 1% wt/wt to about 50% wt/wt.

In a second aspect, the invention relates to an electrocoagulation system for removing contaminants from a flow of wastewater comprising a wastewater for receiving and holding wastewater; an electrocoagulation reactor having a plurality of electrodes comprising an aluminum alloy, the plurality of electrodes being substantially parallel to the each other; a DC voltage source in electrical communication with the plurality of electrodes for applying a voltage therebetween, the voltage causing the contaminants in the wastewater to react with the electrodes to change from in-solution to in-suspension in the wastewater; a rectifier in electrical communication with the DC voltage source to selectively reverse the polarity of the voltage supplied to the electrode plates thus changing the polarity of the electrode plates to allow the electrode plates to deteriorate substantially equally, the rectifier being controlled by the controller; and a controller adapted to control the flow of wastewater from the wastewater source, through the electrocoagulation reactor, and into the settling tanks, the controller controlling the DC voltage source to control the amount of voltage supplied to the electrode plates. The rectifier may change the polarity of the electrode plates to allow the electrode plates to deteriorate substantially equally and to maintain electrical potential between adjacent plates, the rectifier being controlled by the controller. Each of the plurality of electrode plates may be comprised of an aluminum alloy. The aluminum alloy may comprise aluminum, chromium, and magnesium. The aluminum alloy may be 5052 aluminum alloy. The positive and negative electrode plates may have a substantially rectangular shape with an angled cut at one distal end thereof. The system may further comprise a temperature sensor to measure the temperature of the wastewater exiting the reactor, the temperature sensor in communication with the controller, the controller adjusting the flow of wastewater and the DC voltage source to achieve a desired temperature of wastewater exiting the reactor. The system may further comprise a pH sensor located between the reactor and the settling tanks to measure the pH of the wastewater exiting the reactor, the pH sensor being in communication with the controller, wherein the controller is operable to adjust the flow of wastewater and the DC voltage source to achieve a desired pH of wastewater exiting the reactor. The electrode plates may be vertically disposed. Each of the plurality of electrode plates may have a positive lead and a negative lead in electrical communication with the rectifier. The system may further comprise a pump operable to move the wastewater from the wastewater container to the electrocoagulation reactor and the plurality of settling tanks. The wastewater may comprise concentrations of pesticides in a range of about 1% wt/wt to about 50% wt/wt. The system may be operable to remove the pesticides to achieve a filtrate having a concentration of pesticides in a range of about 1% wt/wt to about 50% wt/wt. The wastewater may comprise concentrations of herbicides in a range of about 1% wt/wt to about 50% wt/wt. The system may be operable to remove the herbicides to achieve a filtrate having a concentration of pesticides in a range of about 1% wt/wt to about 50% wt/wt. The wastewater may comprise concentrations of organic pollutants in a range of about 1% wt/wt to about 50% wt/wt. The system may be operable to remove the organic pollutants to achieve a filtrate having a concentration of pesticides in a range of about 1% wt/wt to about 50% wt/wt. The system may be operable to apply a current to the electrodes in a range of about 550 amps to about 700 amps and to pass the wastewater through the electrocoagulation reactor at a rate in a range of about 0.5 gallons/minute to about 15 gallons/minute, and thereby remove the organic pollutants to achieve a filtrate having a concentration of pesticides in a range of about 1% wt/wt to about 50% wt/wt.

In a third aspect, the present invention relates to an electrocoagulation method for treating wastewater containing contaminants in-solution comprising collecting the wastewater in a container; passing the wastewater from the container to an electrocoagulation reactor, the reactor having a plurality of electrode plates; applying a voltage to the electrode plates from a DC voltage source to form suspended particles in the wastewater, wherein the polarity of the voltage applied to adjacent electrode plates is opposite to create an electrical potential between the adjacent electrode plates; moving the wastewater with the suspended particles from the electrocoagulation reactor to a plurality of settling tanks; removing the suspended particles from the wastewater by flowing the wastewater through the plurality of settling tanks which causes the suspended particles to drop out of the wastewater; and extracting a filtrate from the plurality of settling tanks. The electrocoagulation method may further comprise using a rectifier to selectively reverse the polarity of the DC voltage source to reverse the polarity of voltage supplied to the adjacent electrode plates to maintain the electrical potential between the adjacent electrode plates. The polarity of the DC voltage may be reversed by the rectifier at an interval in a range of about 15 seconds to about 90 seconds. The polarity of the DC voltage may be reversed by the rectifier at an interval of about one minute or less. An electronic controller may control a pump to direct the flow rate of wastewater from the wastewater source, through the electrocoagulation reactor, and into the settling tanks, and controls the rectifier and the DC voltage source to direct the amount and polarity of voltage supplied to the plurality of electrode plates. The rectifier may change the polarity of the adjacent electrode plates to allow the electrode plates to deteriorate substantially equally and to maintain electrical potential between adjacent plates, the rectifier being controlled by the controller. The plurality of electrode plates may be comprised of an aluminum alloy. The aluminum alloy may comprise aluminum, chromium, and magnesium. The electrocoagulation aluminum alloy may be 5052 aluminum alloy. The plurality of electrode plates may have a substantially rectangular shape with an angled cut at one distal end thereof. A pH sensor may be located between the electrocoagulation reactor and the settling tanks, and may measure the pH of the wastewater exiting the electrocoagulation reactor, the pH sensor being in communication with the controller. The electrode plates may be vertically disposed. Each of the plurality of electrode plates may have a positive lead and a negative lead in electrical communication with the rectifier. The wastewater may comprise concentrations of pesticides in a range of about 1% wt/wt to about 50% wt/wt. The system may be operable to remove the pesticides to achieve a filtrate having a concentration of pesticides in a range of about 1% wt/wt to about 50% wt/wt. The wastewater may comprise concentrations of herbicides in a range of about 1% wt/wt to about 50% wt/wt. The system may be operable to remove the herbicides to achieve a filtrate having a concentration of pesticides in a range of about 1% wt/wt to about 50% wt/wt. The wastewater may comprise concentrations of organic pollutants in a range of about 1% wt/wt to about 50% wt/wt. The system may be operable to remove the organic pollutants to achieve a filtrate having a concentration of pesticides in a range of about 1% wt/wt to about 50% wt/wt. The method may include applying a current to the electrodes in a range of about 550 amps to about 700 amps and the wastewater is passed through the electrocoagulation reactor at a rate in a range of about 0.5 gallons/minute to about 15 gallons/minute, and the organic pollutants are thereby removed to achieve a filtrate having a concentration of pesticides in a range of about 1% wt/wt to about 50% wt/wt.

Further aspects and embodiments will be apparent to those having skill in the art from the description and disclosure provided herein.

It is an object of the present invention to provide an improved electrocoagulation method effective for removing organic molecular contaminants from wastewater.

It is a further object of the present invention to provide an effective and efficient method for removing organic molecular contaminants from wastewater without using added chemicals or materials.

It is a further object of the present invention to provide a simple and automatable method for removing organic molecular contaminants from wastewater.

It is a further object of the present invention to provide an improved method effective for removing organic molecular contaminants from wastewater without producing toxic or unstable bioproducts.

The above-described objects, advantages and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 provides a perspective view of an electrocoagulation system, according to an embodiment of the present invention.

FIG. 2 provides a front perspective view of the electrocoagulation contact reactor, according to an embodiment of the present invention.

FIG. 3 provides a cross-sectional perspective view of a electrocoagulation contact reactor, according to an embodiment of the present invention.

FIG. 4 provides a side cross-sectional view of the electrocoagulation contact reactor, according to an embodiment of the present invention.

FIG. 5 provides a perspective view cross-sectional view of the electrocoagulation reactor, according to an embodiment of the present invention.

FIG. 6 provides a perspective view of the reusable bag system, according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

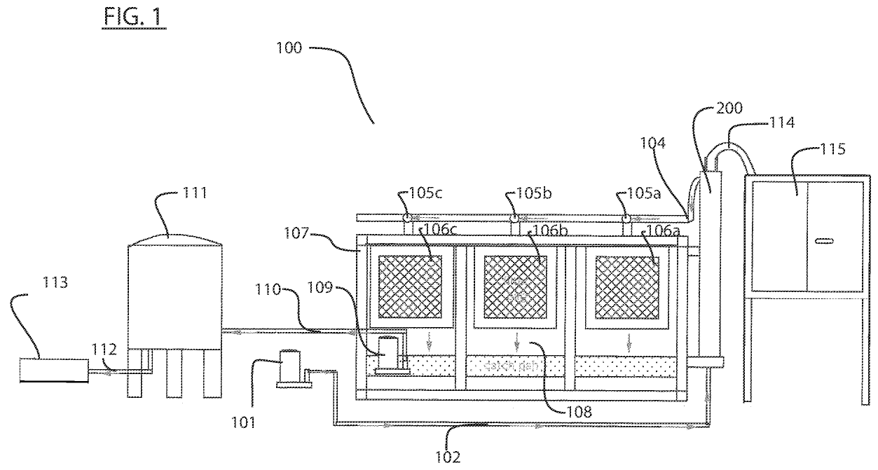

FIG. 1 depicts an illustration of a flow diagram of an exemplary electrocoagulation fluid system 100 according to an embodiment of the present invention. The system 100 may include three major components, including a rectifier 115, a reaction tower 200, and settling system 107. The rectifier 115 may be operable to apply high voltage and current levels to the electrocoagulation tower 200 with polarity switching operability at pre-determined intervals that maintains electrical potential in the wastewater sufficient to chemically breakdown the contaminants at a consistent rate, thereby increasing the efficiency and efficacy of the system 100. The voltages applied by the rectifier of the presently disclosed systems and methods may be in a range of about 12 V to about 40 V. The currents applied in the present system may be about 400 amps to about 1500 amps (e.g., about 500 amps to about 900 amps).

The reaction tower 200 may comprise an electrocoagulation reactor system designed to optimize the exposure time, mixing of the fouled water passing through the electrocoagulation reactor, and the ratio of the surface area of the electrodes to the volume of the fouled water flowing through the reaction tower 200. The geometry and material of the electrode plates in the reaction tower are novel and improve the efficiency of the electrocoagulation performed by reaction tower 200. The electrodes of the reaction tower 200 include relatively large electrode surface areas relative to the volume of the contaminated fluid within the reaction tower 200. The parallel plate electrodes are disposed on the support enclosure so as to be parallel with the direction of fluid flow between the electrode plates and from a proximal end of the reaction tower 200 to a distal end of the reaction tower 200.

The electrocoagulation fluid system 100 may further include pumps to move the fluid through the major reaction tower 200 and the settling structure 107. The system may include a pump 101 operable to move fluid through a pipe 102 to the electrocoagulation reactor 200. The fluid may then flow to a pipe junction 104 and may be deposited into one of the filter bags 106a, 106b, or 106c in the settling system 107 from the orifice valves 105a, 105b, and 105c. An additional pump 109 may siphon the filtrate from the settling tanks to a collection tank 111 through a conduit 110. The system may further have a pressure release valve 211, which is connected to a control cable 212.

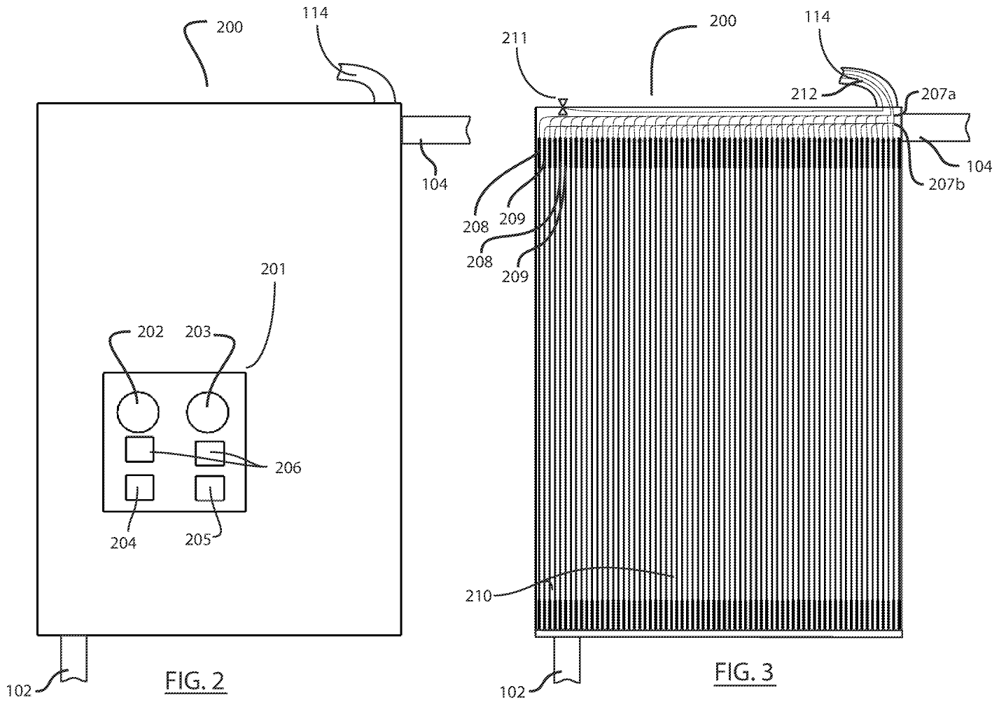

FIG. 2 depicts an illustration of a front view of the electrocoagulation reaction tower 200 of the system 100. The electrocoagulation reaction tower 200 may have a monitoring panel 201 for housing various gauges and control mechanism and/or a touchscreen control interface. The controls may include a flow meter gauge 202, a temperature gauge 203, a pressure gauge 204, and a pH gauge 205. The control panel may also support buttons, dials, or other electromechanical controls 206, which may serve a function which may include controlling power output from the rectifier 200, the polarity switching period of the power supplied to the electrodes, the flow rate of the contaminated fluid through the system 100 by controlling, e.g., the pumps 101 and 109, opening or closing a pressure release valve, and closing and opening the orifice valves 105a, 105b, and 105c.

Also shown in FIG. 2, a contaminated fluid conduit 102 provides the contaminated fluid from a contaminated fluid source 101 that contains about 1% wt/wt to about 50% wt/wt of pesticide, herbicide, or other contaminants. The contaminated fluid then passes through the reaction tower 200, in which the electrical potential generated by the high current in the range of about 550 amps to about 700 amps passing through electrodes within the reaction tower 200. The contaminated fluid may flow through the reaction tower 200 as the electrical potential is applied thereto at a rate of about 0.5 gallons/minute to about 15 gallons/minute. As the contaminated fluid passes through the reaction tower 200, the contaminants in the fluid are chemically changed by chemical oxidation-reduction reactions that convert organic materials to less toxic species and to species that are more amenable to coagulation with metal cations produced by the charged electrodes present in the electrocoagulation reaction vessel and the produced chemical species can then agglomerate and come out of solution by migration to oppositely charged electrodes and resulting aggregation due to charge neutralization, precipitate formation between charged pollutants and metal cations and hydroxyl ions, and coagulation to form a flocculant. The flow rate allows sufficient time for these processes to take place. The resulting separated fluid and flocculant and agglomerations are removed from reaction tower 200 through conduit 104 to be transferred to one of the settling chambers 108.

FIG. 3 depicts an illustration of a front cross-sectional view of the electrocoagulation contact reactor 200. The reaction tower 200 may have a series of electrodes 208 and 209, which are connected to a branch sub lead system 207a or 207b. The branch subleads may be bound together within the insulated control line 114. The branch sublead 207a may be connected directly to the electrodes 208. Similarly, the branch sublead 207b may be connected directly to the electrodes 209. The electrodes may be configured in an alternating pattern, where one electrode 208 is wired to be oppositely polarized to the adjacent electrode, such that one is positive when the other is negative. All of the electrodes may be configured to have an even spacing in a range of about 0.1 inches to about 2 inches (e.g., about 0.125 inch to about 0.5 inch), such that a strong electrical potential can be maintained between adjacent electrodes and there is a high surface area to volume ratio between the surface of the electrodes and the volume of the contaminated fluid. The reactor may include 10 to 20 electrodes each having a surface area in a range of about 450 in² to about 1200 in², and the volume of contaminated fluid in the reactor tower 200 at any given moment is in a range of about 12 gallons to about 55 gallons.

FIGS. 4-5 depict the arrangement of the electrodes in the reaction tower 200, with FIG. 4 showing a side cross-sectional view of the electrocoagulation reactor 200, and FIG. 5 showing the arrangement of the electrodes and electrical leads. The electrodes of the reactor tower 200 may be shaped and positioned to create a flow pathway through the reactor that provides spatial closeness between the electrodes to create sufficient potential therebetween, and some turbulence in the water to cause mixing and dispersion of the fouled water to encourage interactions of charged ions (e.g., metal cations, charged metal oxides, etc.) with charged organic materials to maximize complexing and coagulation of the contaminants in the fouled water. The alternating adjacent electrodes 208 and 209 may have a flat, plate structure with a height in a range of about 36 inches to about 84 inches (e.g., about 4 feet, about 5 feet, or any value or range of values therein), each with one distal end cut 210 (a docked end) that allows for a gap between the angled distal end and an interior wall of the reactor 200 to allow the fouled water to flow therebetween. The electrode plates 208 and 209 may be arranged in parallel within the reactor with predetermined spacing between the electrode plates, and the docked ends 210 of the electrode plates in a staggered arrangement such that the docked end 210 of an electrode plate 208 is horizontally flipped with respect to an adjacent electrode plate 209. This arrangement allows for the free flow of the fouled water through the reactor, while still causing turbulence and mixing at the docked ends 210 of the electrode plates 208, 209 due to a convoluted flow pathway created by the staggered docked ends 210 of the electrode plates.

The electrode plates 208, 209 may be spaced apart from each other to improve the ratio of electrode surface area to volume of the volume of fouled water passing through the reactor tower 200. The electrodes 208, 209 may be arranged substantially parallel to each other and may be spaced apart by a distance in a range of about 0.1 inches to about 2 inches (e.g., about 0.125 inch to about 0.5 inch), such that a strong electrical potential is maintained between adjacent electrodes and there is a high surface area to volume ratio between the surface of the electrodes 208, 209 and the volume of fouled water.

Voltages and currents applied to the electrodes 208, 209 according to the presently disclosed methods are higher than in conventional systems, and the electrocoagulation system 100 may utilize a novel rectifier 200 for applying high voltage and current levels to the electrodes 208, 209 with polarity switching operability at pre-determined intervals that maintains electrical potential in the wastewater sufficient to chemically breakdown the contaminants at a consistent rate, thereby increasing the efficiency and efficacy of the system 100. The voltages applied by the rectifier 115 may be in a range of about 12 V to about 40 V. The currents applied by the rectifier 115 may be about 400 amps to about 1500 amps (e.g., about 500 amps to about 900 amps). Large gauge conductive lines (e.g., rods having a diameter in a range of about ¼ in. to about % in) may be used to deliver current from a rectifier 200 to the contact points for the plate electrodes 208, 209 to improve the efficiency of the flow of electricity and facility high voltage and current delivery to the electrode plates 208, 209. The conductive lines may comprise copper, aluminum, gold, platinum, or other highly conductive metals. The conductive lines may each be connected to one more electrodes in the coagulation reaction tower 200 by branching into subleads connecting directly to the plates to deliver electricity thereto. Each of the subleads may be connected to the electrode plates by a high surface area conductive contact (e.g., a clamp) to provide a contact operable to deliver a large amount of voltage and current to the electrode plate efficiently. The connections of the conductive lines may be arranged such that the polarity of the electrodes 208 and 209 alternate between positive and negative, and thus conductive lines of opposite polarity are connected to each set of adjacent electrodes.

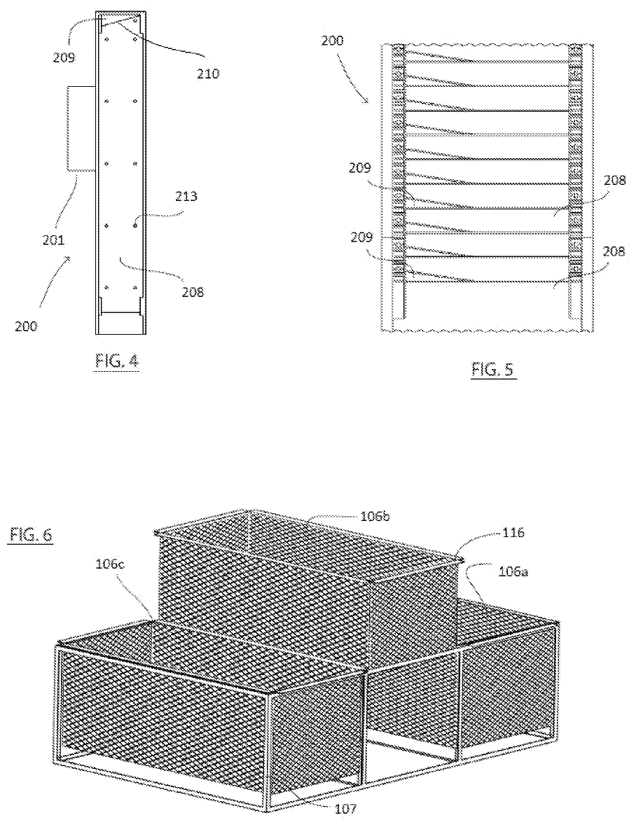

FIG. 6 shows the settling system 107, having a plurality of settling chambers 108 (e.g., three settling chambers). Each of the settling chambers 108 may be separate, each having a filter bag (106a, 106b, 106c) with the same pore size, and working in parallel. The parallel settling chambers 108 allow for simultaneous settling of coagulated contaminant from the reaction tower 200. The effluent fluid may be allowed to remain in the tanks 108 for an extended period to allow for the coagulated material to settle out of the fluid into the filter bags 106a, 106b, and 106c for an extended period. Each of the settling chambers 108 may have a volume in a range of about 50 gallons to about 200 gallons (e.g., in a range of about 80 gallons to about 150 gallons; in a range of about 100 gallons to about 130 gallons; or any value or range of values therein). The volume of the filter bags 106a, 106b, and 106c nested within the settling chambers 108 may each have a volume of about 50% to about 80% of the volume of the settling chamber 108 in which they are nested. The filter bags 106a, 106b, and 106c may have a perimeter shape that is complementary shape to the interior frame of the settling chamber 108, and may be suspended at or near the top rim of the settling chamber 108 such that the vertical depth of the filter bag is less than that of the settling chamber 108. The filtrate passing through the filter bags may be collected in settling chambers 108.

The following is a discussion of the process of electrocoagulation in reference to the drawings. As shown in FIG. 1, the pump 101 may be placed in fluid communication with a contaminated fluid source for intake to the system. The process is commenced once a voltage is applied to the pump 101, which may begin to pass the contaminated fluid from the fluid source through a delivery pipe 102, a volumetric flowrate may be monitored and measured using a flow meter (not shown) and a mass flowrate may be calculated from the pump characteristics in combination with the measured volumetric flowrate in a PLC of the rectifier 115. The contaminated fluid may subsequently begin to fill the control volume within the electrocoagulation reactor tower 200 for treatment.

Referring to FIG. 2-FIG. 5, the contaminated fluid may enter the coagulation reactor 200 from the pipe 102 and fill the control volumes 210 between the alternating electrode plates 208 and 209. The electrode plates may then be applied a high electrical power, e.g., 500 amps at 12V, from the branch sub leads 207a and 207b, the applied voltage subjects the contaminants in water to be in a statically held within the control volume 210. The flow of untreated water from pipe 102 may be halted when the voltage is applied. The contaminants undergo a redox reaction with the electrode plates 208 and 209, and the contaminated fluid forms into clumps of emulsion (e.g., coagulation). The polarization of the electrode plates 208 and 209 may be reversed about every 30 seconds to about 90 seconds to prevent charge accumulation and continue to apply a high electrical potential to the particulates in the fluid, and the flow may proceed to allow the treated fluid and clumps of emulsion to flow to the pipe junction 104.

The coagulated fluid effluent may then flow through the pipe junction 104 and out of the orifice valve 105a, 105b, and 105c into the settling tanks 108, where the effluent passes through the filter bags 106a, 106b, and 106c, and the coagulated material settles in the filter bags 106a, 106b, and 106c. The filter bags 106a, a06b, and 106c function to collect and separate the hydrophobic coagulated contaminants (e.g., sludge) from a filtrate that passes out of the filter bags into the settling tanks 108. The pump 109 may work the filtrate into a filtrate collection tank 111. The filtrate may then be drawn from the collection tank 111 through a conduit 112 to recycle use system 113 (e.g., an irrigation system). The reusable filter bags 106a, 106b, and 106c when filled may be removed from the settling structure 107 for washing.

FIG. 6 depicts an illustration of the method for removing the reusable filter bags of the system of FIG. 1. The bags 106a, 106b, and 106c have a rigid flange 116 that functions to support and secure the reusable bag within the structure 107. The reusable bag may be lifted laterally out of the structure and cleaned of all sludge (e.g., coagulated material).

Example 1: The following volumes of chemicals were diluted in 150 gallons of water as a test solution for examining the efficacy of the electrocoagulation system described herein:

| Chemical Name | Quantity | |
|---|---|---|
| Agri-Mek SC | 1 | quart |
| Mustang | 1 | quart |
| Dupont Coragen 28 | 1 | quart |
| Dupont Avaunt | 1 | quart |
| Warrior II 3 | 1 | quart |
| Assail 70 WP | 28 | oz. |
| Adamex 6 | 1 | quart |
| Sniper 3A | 1 | quart |
| Radiant SC | 1 | quart |
| Sivanto Prime | 1 | quart |
| Dibrom 8 Emulsive | 1 | quart |
| Acephate 97UP | 16 | oz. |
| Lannate SP | 21 | lbs. |

The solution was then passed through the electrocoagulation system as described herein with the electrical power provided by the rectifier to the electrodes in the reaction tower at 500 amps with a voltage of 12V. The solution was passed through the reaction tower at a rate of 0.5 gallons/minute. The coagulated materials were removed by passage of the water/particulate suspension through the filter bags and settling chambers. The resulting filtrate was lab tested under the federal Toxic Characteristic Leaching Procedure (TCLP) and California's Total Threshold Limit Concentration (TTLC) protocols for determining the level of toxic materials in the filtrate. A table of the lab results for several tested chemicals and the federal TCLP and California TTLC standards is provided below. As shown in the table, the filtrate produced by the presently disclosed electrocoagulation system was able to reduce the relevant contaminant levels sufficiently to meet both federal and California standards.

| | Filtrate | | | | |
|---|---|---|---|---|---|
| Contam- | Concentration | TCLP Standard | | TTLC Standard | |
| inants | mg/L | mg/L | | mg/L | |
| Arsenic | 0.048 | 0.5 | (500 mg/kg) | 0.005 | (5 mg/kg) |
| Barium | 0.15 | 10 | (10000 mg/kg) | 0.1 | (100 mg/kg) |
| Lead | 2.3 | 1 | (1000 mg/kg) | 0.005 | (5 mg/kg) |

Example 2: The following volumes of chemicals were diluted in 15 gallons of water as a test solution for examining the efficacy of the electrocoagulation system described herein:

| Chemical Name | Quantity | |
|---|---|---|
| Action, Amvac Chemical - 59639-82-AA-5481 - | 0.47 | Gallon |
| Flumiclorac-pentyl C21H23ClFNO5 | | |
| ET Herbicide/Defoliant - Nichino America - 71711-7 - | 0.21 | Gallon |
| pyraflufen-ethyl C15H13Cl2F3N2O4 | | |
| Freeway, UAP - Loveland Industries - 34704-50031 - | 0.63 | Gallon |
| Adjuvant - Dimethylpolysiloxane, Silicone-polyether | | |
| copolymer, propylene glycol, ethoxylated C12-branched | | |
| organic alcohols | | |
| Integrate Humic Acid | 2.5 | Gallon |
| PointBlank WM, Helena Chemicals - 5905-50102 - | 0.02 | Gallon |
| polyacrylamide Adjuvant | | |

The solution was then passed through the electrocoagulation system as described herein with the electrical power provided by the rectifier to the electrodes in the reaction tower at 600 amps with a voltage of 12V. The solution was passed through the reaction tower at a rate of between 3 and 6 gallons/minute. The coagulated materials were removed by passage of the water/particulate suspension through the filter bags and settling chambers. The resulting filtrate was lab tested under the federal Toxic Characteristic Leaching Procedure (TCLP) and California's Total Threshold Limit Concentration (TTLC) protocols for determining the level of toxic materials in the filtrate. A table of the lab results for several tested chemicals and the federal TCLP and California TTLC standards is provided below. As shown in the table, the filtrate produced by the presently disclosed electrocoagulation system was able to reduce the relevant contaminant levels sufficiently to meet both federal and California standards.

| | Filtrate Concentration | TTLC Standard |
|---|---|---|
| Contaminants | mg/kg | mg/kg |
| Barium | 11 | 10000 |
| Cadmium | 1.2 | 100 |
| Chromium | 28 | 2500 |
| Copper | 34 | 2500 |
| Zinc | 710 | 5000 |
| 1-Methylnaphthalene | 2.47 | |
| 2-Methylnaphthalene | 3.37 | |
| n-Butylbenzene | 38.3 | |
| Carbon disulfide | 90.8 | |

The metal contaminants all tested below the TTLC standard levels. Also, though there are not specific TTLC standards for the organic contaminants in the filtrate, the organic materials were also significantly reduced by the electrocoagulation process.

As shown in the example results, the present electrocoagulation system and methods are capable of removing organic materials, such as pesticides and herbicides, metal contaminants, and other contaminants from contaminated fluids to a much lower level than conventional techniques. The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. An electrocoagulation system for removing contaminants from a flow of wastewater comprising:
a) a wastewater container for receiving and storing wastewater;
b) an electrocoagulation reactor in fluid communication with the wastewater container having a plurality of electrode plates positioned at a predetermined spacing and substantially parallel to each other;
c) a DC voltage source in electrical communication with the plurality of electrode plates for applying a voltage therebetween;
d) a rectifier in electrical communication with the DC voltage source to selectively reverse the polarity of the voltage supplied to the electrode plates at a predetermined interval; and
e) a plurality of settling tanks having filter membranes for collecting coagulated materials from said wastewater.

2. The system of claim 1, further comprising a controller adapted to control the flow of wastewater from the wastewater source, through the electrocoagulation reactor, and into the settling tanks, and to control the rectifier and the DC voltage source to control the amount of voltage supplied to the plurality of electrode plates.

3. The system of claim 1, wherein the rectifier changes the polarity of the electrode plates to allow the electrode plates to deteriorate substantially equally and to maintain electrical potential between adjacent plates, the rectifier being controlled by the controller.

4. (canceled)

5. (canceled)

6. (canceled)

7. (canceled)

8. The system of claim 1, further comprising a temperature sensor to measure the temperature of the wastewater exiting the reactor, the temperature sensor in communication with the controller, the controller adjusting the flow of wastewater and the DC voltage source to achieve a desired temperature of wastewater exiting the reactor.

9. The system of claim 1, further comprising a pH sensor located between the reactor and the settling tanks to measure the pH of the wastewater exiting the reactor, the pH sensor being in communication with the controller, wherein the controller is operable to adjust the flow of wastewater and the DC voltage source to achieve a desired pH of wastewater exiting the reactor.

10. (canceled)

11. (canceled)

12. (canceled)

13. (canceled)

14. (canceled)

15. (canceled)

16. (canceled)

17. The system of claim 1, wherein said wastewater comprises concentrations of organic pollutants in a range of about 1% wt/wt to about 50% wt/wt, wherein said system is operable to remove said organic pollutants to achieve a filtrate having a concentration of pesticides in a range of about 1% wt/wt to about 50% wt/wt.

18. (canceled)

19. The system of claim 17, wherein said system is operable to apply a current to said electrodes in a range of about 550 amps to about 700 amps and to pass said wastewater through said electrocoagulation reactor at a rate in a range of about 0.5 gallons/minute to about 15 gallons/minute, and thereby remove said organic pollutants to achieve a filtrate having a concentration of pesticides in a range of about 1% wt/wt to about 50% wt/wt.

20. An electrocoagulation system for removing contaminants from a flow of wastewater comprising:
a) a wastewater for receiving and holding wastewater;
b) an electrocoagulation reactor having a plurality of electrodes comprising an aluminum alloy, the plurality of electrodes being substantially parallel to the each other;
c) a DC voltage source in electrical communication with the plurality of electrodes for applying a voltage therebetween, the voltage causing the contaminants in the wastewater to react with the electrodes to change from in-solution to in-suspension in the wastewater;
d) a rectifier in electrical communication with the DC voltage source to selectively reverse the polarity of the voltage supplied to the electrode plates thus changing the polarity of the electrode plates to allow the electrode plates to deteriorate substantially equally, the rectifier being controlled by the controller; and
e) a controller adapted to control the flow of wastewater from the wastewater source, through the electrocoagulation reactor, and into the settling tanks, the controller controlling the DC voltage source to control the amount of voltage supplied to the electrode plates.

21. The system of claim 20, wherein the rectifier changes the polarity of the electrode plates to allow the electrode plates to deteriorate substantially equally and to maintain electrical potential between adjacent plates, the rectifier being controlled by the controller.

22. (canceled)

23. (canceled)

24. (canceled)

25. (canceled)

26. The system of claim 20, further comprising a temperature sensor to measure the temperature of the wastewater exiting the reactor, the temperature sensor in communication with the controller, the controller adjusting the flow of wastewater and the DC voltage source to achieve a desired temperature of wastewater exiting the reactor.

27. The system of claim 20, further comprising a pH sensor located between the reactor and the settling tanks to measure the pH of the wastewater exiting the reactor, the pH sensor being in communication with the controller, wherein the controller is operable to adjust the flow of wastewater and the DC voltage source to achieve a desired pH of wastewater exiting the reactor.

28. (canceled)

29. (canceled)

30. (canceled)

31. (canceled)

32. (canceled)

33. (canceled)

34. (canceled)

35. (canceled)

36. (canceled)

37. The system of claim 20, wherein said system is operable to apply a current to said electrodes in a range of about 550 amps to about 700 amps and to pass said wastewater through said electrocoagulation reactor at a rate in a range of about 0.5 gallons/minute to about 15 gallons/minute, and thereby remove said organic pollutants to achieve a filtrate having a concentration of pesticides in a range of about 1% wt/wt to about 50% wt/wt.

38. An electrocoagulation method for treating wastewater containing contaminants in-solution comprising:
collecting the wastewater in a container;
passing the wastewater from the container to an electrocoagulation reactor, the reactor having a plurality of electrode plates;
applying a voltage to the electrode plates from a DC voltage source to form suspended particles in the wastewater, wherein the polarity of the voltage applied to adjacent electrode plates is opposite to create an electrical potential between the adjacent electrode plates;
moving the wastewater with the suspended particles from the electrocoagulation reactor to a plurality of settling tanks;
removing the suspended particles from the wastewater by flowing the wastewater through the plurality of settling tanks which causes the suspended particles to drop out of the wastewater;
extracting a filtrate from the plurality of settling tanks.

39. The electrocoagulation method of claim 38, further comprising using a rectifier to selectively reverse the polarity of the DC voltage source to reverse the polarity of voltage supplied to the adjacent electrode plates to maintain the electrical potential between the adjacent electrode plates.

40. The electrocoagulation method of claim 39, wherein the polarity of the DC voltage is reversed by the rectifier at an interval in a range of about 15 seconds to about 90 seconds.

41. The electrocoagulation method of claim 39, wherein the polarity of the DC voltage is reversed by the rectifier at an interval of about one minute or less, wherein the rectifier changes the polarity of the adjacent electrode plates to allow the electrode plates to deteriorate substantially equally and to maintain electrical potential between adjacent plates, the rectifier being controlled by the controller.

42. The electrocoagulation method of claim 39, wherein an electronic controller controls a pump to direct the flow rate of wastewater from the wastewater source, through the electrocoagulation reactor, and into the settling tanks, and controls the rectifier and the DC voltage source to direct the amount and polarity of voltage supplied to the plurality of electrode plates.

43. (canceled)

44. (canceled)

45. (canceled)

46. (canceled)

47. (canceled)

48. The electrocoagulation method of claim 38, wherein a pH sensor located between the electrocoagulation reactor and the settling tanks measures the pH of the wastewater exiting the electrocoagulation reactor, the pH sensor being in communication with the controller.

49. (canceled)

50. (canceled)

51. (canceled)

52. (canceled)

53. (canceled)

54. (canceled)

55. The electrocoagulation method of claim 38, wherein said wastewater comprises concentrations of organic pollutants in a range of about 1% wt/wt to about 50% wt/wt, wherein said system is operable to remove said organic pollutants to achieve a filtrate having a concentration of pesticides in a range of about 1% wt/wt to about 50% wt/wt.

56. (canceled)

57. The electrocoagulation method of claim 42, wherein a current is applied to said electrodes in a range of about 550 amps to about 700 amps and said wastewater is passed through said electrocoagulation reactor at a rate in a range of about 0.5 gallons/minute to about 15 gallons/minute, and said organic pollutants are thereby removed to achieve a filtrate having a concentration of pesticides in a range of about 1% wt/wt to about 50% wt/wt.
